(19) United States
(12) Patent Application Publication
(10) Pub. No.: US 2020/0266492 A1
(43) Pub. Date: Aug. 20, 2020

(54) LITHIUM ION ELECTROCHEMICAL CELL OPERATING AT A HIGH TEMPERATURE

(71) Applicant: SAFT, Levallois-Perret (FR)

(72) Inventors: Erwan DUMONT, AMBARES ET LAGRAVE (FR); Frédéric CASTAING, GRADIGAN (FR); Benjamin LE GUERN, LES ROCHES PREMARIE (FR); Fabrice RENE, CHIRE EN MONTREUIL (FR); Michel ULLDEMOLINS, BORDEAUX (FR); Cécile TESSIER, BRUGES (FR); Jean-Paul PERES, NOUAILLE-MAUPERTUIS (FR); Florent FISCHER, BRUGES (FR)

(73) Assignee: SAFT, Levallois-Perret (FR)

(21) Appl. No.: 16/647,979

(22) PCT Filed: Oct. 1, 2018
(86) PCT No.: PCT/EP2018/076674

§ 371 Date: Mar. 17, 2020

(30) Foreign Application Priority Data
Oct. 2, 2017 (FR) 1759169

(51) Int. Cl. H01M 10/0569; H01M 2/16; H01M 4/62; H01M 4/74; H01M 10/0525

(52) U.S. Cl. CPC H01M 10/0569; H01M 2/1606; H01M 2300/0045; H01M 4/745; H01M 10/0525; H01M 4/622

(57) ABSTRACT

A lithium-ion electrochemical cell comprising:
at least one negative electrode comprising an active material having an operating potential greater than or equal to 1 V with respect to the potential of the electrochemical couple Li⁺/Li;
at least one positive electrode;
the negative electrode and/or the positive electrode comprising a binder selected from polytetrafluoroethylene, polyamideimide, polyimide, styrene-butadiene rubber and polyvinyl alcohol or a mixture thereof;
a liquid electrolyte comprising a solvent which is an ionic liquid;
a separator having a shrinkage of less than or equal to 3% in the direction of its length and in the direction of its width, after exposure to a temperature of 200° C. for a period of at least one hour.

This electrochemical cell can be used in charge or discharge at a temperature ranging from room temperature to 150° C. or higher.

### TECHNICAL FIELD

The technical field of the invention is that of rechargeable lithium-ion electrochemical cells capable of operating at high temperature, i.e. at a temperature greater than or equal to 150° C., without a significant degradation of their electrical performance being observed.

### PRIOR ART

Rechargeable lithium-ion electrochemical cells are known in the prior art. Because of their high mass and volume energy density, they are a promising source of electrical energy. They comprise at least one positive electrode, which may be a lithiated transition metal oxide, and at least one negative electrode, which may be graphite-based. However, such cells have a limited service life when used at a temperature of at least 150° C. because at this temperature, their constituents degrade rapidly, causing either a short circuit in the cell or an increase in its internal resistance. It can be observed on cells that do not short-circuit at 150° C. that after approximately five charge/discharge cycles carried out at 150° C., the restored capacity only represents approximately 20% of their initial capacity. After ten charge/discharge cycles, the remaining capacity is less than 10%. The temperature of 125° C. appears to be the limit beyond which rapid degradation of the electrical performance of a rechargeable lithium-ion electrochemical cell is observed. Electrochemical cells comprising a lithium-based electrode are certainly capable of operating at temperatures greater than or equal to 150° C., but they are non-rechargeable electrochemical cells, also called primary electrochemical cells, which are excluded from the scope of the present invention.

Research has been conducted to develop rechargeable lithium-ion electrochemical cells capable of operating at high temperatures. Such cells are for example described in EP-A-1 619 741. This teaches the use of a positive active material based on LiNiO₂, preferably obtained by substitution in LiNiO₂ of part of the nickel by cobalt and/or by aluminum. The salt used in the electrolyte of the electrochemical cell is a lithium salt selected from: LiPF₆, LiBF₄, LiBOB (lithium bis oxalatoborate), LiBETI (lithium bisperfluoroethylsulfonylimide) or a mixture thereof. It is said that this cell is capable of operating at a temperature between 60° C. and 180° C.

In addition, a way is being sought to increase the weight per unit area of a lithium-ion electrochemical cell electrode. The positive and negative electrochemically active materials of a lithium-ion electrochemical cell are usually mixed with one or more compounds having the function of a binder, as well as with one or more compounds having high electrical conduction properties. The mixture containing the positive (respectively negative) active material, the binder(s) and the compound(s) with high electrically conductive properties is deposited on the current collector of the positive (respectively negative) electrode. The mass of mixture deposited per unit area of the current collector is referred to as the electrode weight per unit area. An increase in the weight per unit area of the positive or negative electrode leads to an increase in the capacity of the electrochemical cell.

A first objective of the invention is therefore to provide novel lithium-ion electrochemical cells capable of operating in charge and discharge at a temperature of at least 150° C. and whose electrodes have a high weight per unit area.

A second objective of the invention is to be able to manufacture said cells in a cylindrical format.

### SUMMARY OF THE INVENTION

The first objective is achieved by providing a lithium-ion electrochemical cell comprising:
at least one negative electrode comprising an active material having an operating potential greater than or equal to 1 V with respect to the potential of the electrochemical couple Li⁺/Li;
at least one positive electrode;
the negative electrode and/or the positive electrode comprising a binder selected from polytetrafluoroethylene, polyamideimide, polyimide, styrene-butadiene rubber and polyvinyl alcohol or a mixture thereof;
a liquid electrolyte comprising a solvent which is an ionic liquid;
a separator having a shrinkage of less than or equal to 3% in the direction of its length and in the direction of its width, after exposure to a temperature of 200° C. for a period of at least one hour.

The electrochemical cell which is the subject matter of the invention is capable of operating in charge and discharge over a wide temperature range, i.e. from room temperature (about 25° C.) to a temperature of at least 150° C. The expression “capable of operating at a temperature of at least 150° C.” means that the electrochemical cell can be used for at least 200 hours at a temperature of 150° C. without observing a loss of capacity greater than 30% of its initial capacity.

The particular binder composition used for the positive and/or negative electrode is compatible with use of the lithium-ion cell at a temperature of at least 150° C. It also allows a high electrode weight per unit area to be achieved.

According to an embodiment, the separator also has the additional property that it can be wound around a cylinder with a diameter of 3 mm or more without tearing the separator.

According to an embodiment, the active material having an operating potential greater than or equal to 1 V with respect to the electrochemical couple potential Li⁺/Li is selected from the group consisting of:

a) LiaTibO₄ where 0.5≤a≤3 and 1≤b≤2.5;
b) LiₓMg_{y}Ti_{z}O₄ where x>0; 0.01≤y≤0.20; z>0; 0.01≤y/z≤0.10 and 0.5≤(x+y)/z≤1.0;
c) Li_{4+y}Ti_{5-d}M²_{d}O₁₂ where M² is at least one element selected from the group consisting of Mg, Al, Si, Ti, Zn, Zr, Ca, W, Nb, and Sn, with −1≤y≤3.5 et 0≤d≤0.1;
d) H₂Ti₆O₁₃;
e) H₂Ti₁₂O₂₅;

### f) TiO₂;

g) LiₓTiNb_{y}O_{z} where 0≤x≤5; 1≤y≤24; 7≤z≤62;
h) LiₐTiM_{b}Nb_{c}O_{7+σ}, where 0≤a≤5; 0≤b≤0.3; 0≤c≤10; −0.3≤σ≤0.3 and M is at least one element selected from the group consisting of Fe, V, Mo and Ta;
i) Nb_{α}Ti_{β}O_{7+γ} where 0≤α≤24; 0≤β≤1; −0.3≤γ≤0.3;
and mixtures thereof.

Preferably, the active material having an operating potential greater than or equal to 1 V with respect to the potential of the electrochemical couple Li⁺/Li is Li₄Ti₅O₂.

According to an embodiment, the active material with an operating potential greater than or equal to 1 V with respect to the potential of the electrochemical couple Li⁺/Li, has a carbon-based coating.

According to an embodiment, the separator is selected from the group consisting of:
a polyester-based separator,
a separator based on glass fibers bonded together by a polymer,
a polyimide-based separator,
a polyamide-based separator,
a polyamideimide-based separator,
a polyaramide-based separator, and
a cellulose-based separator.

According to an embodiment, the separator contains or is coated with a material selected from the group consisting of a metal oxide, a carbide, a nitride, a boride, a silicide and a sulfide.

According to an embodiment, the ionic liquid is selected from the group consisting of:
1-butyl 1-methyl pyrrolidinium bis(trifluoromethylsulfonyl)imide (BMP-TFSI),
1-butyl 1-methyl pyrrolidinium tris(pentafluoroethyl)trifluorophosphate (BMP-FAP),
ethyl-(2-methoxyethyl) dimethyl ammonium bis(trifluoromethylsulfonyl)imide,
1-methyl 1-propyl piperidinium bis(trifluoromethylsulfonyl)imide.

According to an embodiment, the electrochemical cell comprises a lithium salt dissolved in the ionic liquid, which salt is selected from the group consisting of:
lithium hexafluorophosphate LiPF₆,
lithium tris(pentafluoroethyl)trifluorophosphate LiFAP,
lithium bisoxalatoborate LiBOB,
lithium hexafluoroarsenate LiAsF₆,
lithium tetrafluoroborate LiBF₄,
lithium trifluoromethanesulfonate LiCF₃SO₃,
lithium trifluoromethane sulfonimide LiN(CF₃SO₂)₂(LiTFSI) and lithium trifluoromethanesulfonemethide LiC(CF₃SO₂)₃(LiTFSM), preferably LiTFSI.

According to an embodiment, the negative electrode and/or the positive electrode comprises a current collector which is a metal grid. The use of a current collector in the form of a grid in the positive and/or negative electrode of the electrochemical cell described above further increases the weight per unit area of the electrode. The use of such a current collector enables the weight per unit area of the electrode to be increased to a value of at least 20 mg of mixture per cm² of current collector surface per face, whereas conventional weight per unit area values observed for a lithium-ion electrochemical cell are generally in the range of 6 to 13 mg of mixture per cm² of current collector surface per face.

The metal of the grid can be aluminum or an aluminum-based alloy.

According to an embodiment, the grid has a thickness of less than or equal to 500 μm, preferably less than or equal to 300 μm.

According to an embodiment, the electrochemical cell comprises at least one positive electrode comprising an active material selected from the group consisting of:
compound i) of formula LiₓMn_{1-y-z}M′_{y}M″_{z}PO₄ (LMP), where M′ and M″ are different from each other and are selected from the group consisting of B, Mg, Al, Si, Ca, Ti, V, Cr, Fe, Co, Ni, Cu, Zn, Y, Zr, Nb and Mo, with 0.8≤x≤1.2; 0≤y≤0.6; 0≤z≤0.2;
a compound ii) of formula LiₓFe_{1-y}M_{y}PO₄ (LFMP) where M is selected from the group consisting of B, Mg, Al, Si, Ca, Ti, V, Cr, Mn, Co, Ni, Cu, Zn, Y, Zr, Nb and Mo; and 0.8≤x≤1.2; 0≤y≤0.6,
a compound iii) of formula LiₓM_{1-y-z-w}M′_{y}M″_{z}M′″_{w}O₂(LMO2) where M, M′, M″ and M′″ are selected from the group consisting of B, Mg, Al, Si, Ca, Ti, V, Cr, Mn, Fe, Co, Ni, Cu, Zn, Y, Zr, Nb, W and Mo provided that at least M or M′ or M″ or M′″ is selected from Mn, Co, Ni, or Fe; M, M′, M″ and M′″ being different from each other; and 0.8≤x≤1.4; 0≤y≤0.5; 0≤z≤0.5; 0≤w≤0.2 and x+y+z+w<2.1.

Finally, the invention relates to the use of an electrochemical cell as described above, in charge or discharge at a temperature greater than or equal to 150° C.

### DESCRIPTION OF THE FIGURES

FIG. 1 shows a view of a current collector in the form of a grid.

FIG. 2 shows the variation in the discharged capacity as a function of the number of cycles performed for electrochemical cells A, B, C and D in Example 1.

FIG. 3 is a graph representing:
the variation of the capacity of the cell E in Example 2 in relation to the mass of active material of the positive electrode of this cell as a function of the number of cycles performed.
the loss of mass capacity of cell E as a function of the number of cycles performed.

FIG. 4 shows the variation of the voltage of cell E as a function of the discharged capacity on the one hand during the initial discharge and on the other hand during the discharge of the control cycle after 24 cycles.

### DISCLOSURE OF EMBODIMENTS

The various constituents of the electrochemical cell will be described in the following:

Negative Active Material:

The negative active material has an operating potential greater than or equal to 1 V with respect to the potential of the electrochemical couple Li⁺/Li. The characteristic that the negative active material has an operating potential greater than or equal to 1 V with respect to the potential of the electrochemical couple Li⁺/Li is an intrinsic characteristic of the active material. It can be easily measured by routine tests for a skilled person. For this purpose, the skilled person makes an electrochemical cell comprising a first electrode consisting of lithium metal and a second electrode comprising the active material whose potential is to be determined with respect to the electrochemical couple Li⁺/Li. These two electrodes are separated by a microporous membrane of polyolefin, typically polyethylene, impregnated with electrolyte, usually a mixture of ethylene carbonate and dimethyl carbonate, in which LiPF₆ is dissolved at a concentration of 1 mol/L. The potential measurement is carried out at 25° C. Negative active materials with an operating potential greater than or equal to 1 V relative to the potential of the electrochemical couple Li⁺/Li are also described in the literature.

The negative active material is preferably selected from the group consisting of:

a) LiaTibO₄ where 0.5≤a≤3 and 1≤b≤2.5;
b) LiₓMg_{y}Ti_{z}O₄ where x>0; z>0; 0.01≤y≤0.20; 0.01≤y/z≤0.10 and 0.5≤(x+y)/z≤1.0;
c) Li_{4+y}Ti_{5-d}M²_{d}O₁₂ where M² is at least one element selected from the group consisting of Mg, Al, Si, Ti, Zn, Zr, Ca, W, Nb, and Sn, with −1≤y≤3.5 and 0≤d≤0.1;
d) H₂Ti₆O₁₃;
e) H₂Ti₁₂O₂₅;

### f) TiO₂;

g) LiₓTiNb_{y}O_{z} where 0≤x≤5; 1≤y≤24; 7≤z≤62;
h) LiₐTiM_{b}Nb_{c}O_{7+σ} where 0≤a≤5; 0≤b≤0.3; 0≤c≤10; −0.3≤σ≤0.3 and M is at least one element selected from the group consisting of Fe, V, Mo and Ta;
i) Nb_{α}Ti_{β}O_{7+γ} where 0≤α≤24; 0≤β≤1; −0.3≤γ≤≤0.3;
and mixtures thereof.

Preferably the negative active material is a compound of type c) of formula Li₄Ti₅O₁₂ which may optionally be coated with a carbon layer.

The presence of lithium metal, carbon or graphite in the negative electrode of the cell is excluded from the invention.

Positive Active Material:

The positive active material is selected from the group consisting of:
compound i) of formula LiₓMn_{1-y-z}M′_{y}M″_{z}PO₄ (LMP), where M′ and M″ are different from each other and are selected from the group consisting of B, Mg, Al, Si, Ca, Ti, V, Cr, Fe, Co, Ni, Cu, Zn, Y, Zr, Nb and Mo, with 0.8≤x≤1.2; 0≤y≤0.6; 0≤z≤0.2;
a compound ii) of formula LiₓFe_{1-y}M_{y}PO₄ (LFMP) where M is selected from the group consisting of B, Mg, Al, Si, Ca, Ti, V, Cr, Mn, Co, Ni, Cu, Zn, Y, Zr, Nb and Mo; and 0.8≤x≤1.2; 0≤y≤0.6;
a compound iii) of formula LiₓM_{1-y-z-w}M′_{y}M″_{z}M′″_{w}O₂ (LMO2) where M, M′, M″ and M′″ are selected from the group consisting of B, Mg, Al, Si, Ca, Ti, V, Cr, Mn, Fe, Co, Ni, Cu, Zn, Y, Zr, Nb, W and Mo provided that at least M or M′ or M″ or M′″ is selected from Mn, Co, Ni, or Fe; M, M′, M″ and M′″ being different from each other; and 0.8≤x≤1.4; 0≤y≤0.5; 0≤z≤0.5; 0≤w≤0.2 and x+y+z+w<2.1;

A first preferred compound i) is a compound in which: M′ or M″ is selected from Fe, Co and Ni or a mixture of these metals.

A second preferred compound i) is a compound in which:
M′ or M″ is Fe;
x=1;
y and/or z are less than 0.40.

In one embodiment, y and/or z are less than 0.25.

A third preferred compound i) is the compound of formula LiMnPO₄.

A preferred compound ii) is the compound of formula LiFePO₄.

A first preferred compound iii) is a compound in which:

M is Ni, M′ is Mn and M″ is Co and

M′″ is selected from B, Mg, Al, Si, Ca, Ti, V, Cr, Mn, Fe, Co, Ni, Cu, Zn, Y, Zr, Nb and Mb, with 0.8≤x≤1.4; 0≤y≤0.5; 0≤z≤0.5; 0≤w≤0.2 and x+y+z+w<2.

According to an embodiment, M is Ni, M′ is Mn and M″ is Co and x=1; 1-y-z-w≤0.60; 0.15≤y≤0.45 and 0.15≤z≤0.25. Mention may be made of LiNi_{0.5}Mn_{0.3}Co_{0.2}O₂; LiNi_{0.6}Mn_{0.2}Co_{0.2}O₂; LiNi_{0.4}Mn_{0.4}Co_{0.2}O₂.

According to an embodiment, M is Ni, M′ is Mn and M″ is Co and x=1; 0.6≤1-y-z-w≤0.85; 0.05≤y≤0.15 and 0.05≤z≤0.15. Mention may be made of LiNi_{0.80}Mn_{0.1}Co_{0.1}O₂.

According to an embodiment, M is Ni, M′ is Mn and M″ is Co and 0.8≤x≤1.4; 2-x-y-z-w≤0.40; 0.25≤y≤0.35 and 0.25≤z≤0.35. Mention may be made of Li₁₊ₓNi_{1/3}Mn_{1/3}Co_{1/3}O₂. A preferred example is LiNi₁₋₃Mn_{1/3}Co_{1/3}O₂.

A second preferred compound iii) is a compound in which:

M is Ni, M′ is Co and M″ is Al and M′″ is B or Mg and

0.9≤x≤1.1; 0.70≤2-x-y-z-w≤0.9; 0.05≤y≤0.25; 0≤z≤0.10 and y+z+w=1. Mention may be made of LiNi_{0.8}Co_{0.1}Al_{0.05}O₂.

Binder for the Positive and Negative Electrodes:

The positive and negative active materials of the lithium-ion electrochemical cell are generally mixed with one or more binders, the function of which is to bind the active material particles together and to bind them to the current collector on which they are deposited.

The binders which can typically be used in the positive and/or negative electrode are selected from the group consisting of polytetrafluoroethylene (PTFE), polyamideimide (PAI), polyimide (PI), styrene-butadiene rubber (SBR), polyvinyl alcohol, and a mixture thereof. The Applicant found that the use of these binders was compatible with the use of the lithium-ion cell at a temperature of at least 150° C. and allowed the weight per unit area of the positive and/or negative electrode to be increased.

The preferred binder for the positive electrode is polytetrafluoroethylene.

The preferred binder for the negative electrode is polytetrafluoroethylene, alone or in combination with polyvinyl alcohol.

Styrene-butadiene rubber (SBR) is the least preferred binder and the positive and/or negative electrode may not contain it.

The use of polyvinylidene fluoride (PVDF) in the positive electrode and/or the negative electrode is excluded from the invention.

Current Collector for the Positive and/or Negative Electrodes:

A current collector in the form of a grid is preferably used for the positive and/or negative electrode. The grid structure allows a better mechanical grip of the active material, by embedding the mixture containing the active material in the openwork parts of the grid. Its use in combination with the above-mentioned binders helps to further increase the adhesion of the active material to the current collector. The use of such a current collector makes it possible to increase the weight per unit area of the electrode to a value of at least 20 mg of mixture per cm² of current collector surface and per face. In general, the invention achieves weight per unit area values in the range of 20 to 25 mg of mixture per cm² of current collector surface and per face. The mixture consists of active material, binder(s) and possibly a compound with high electrical conduction properties.

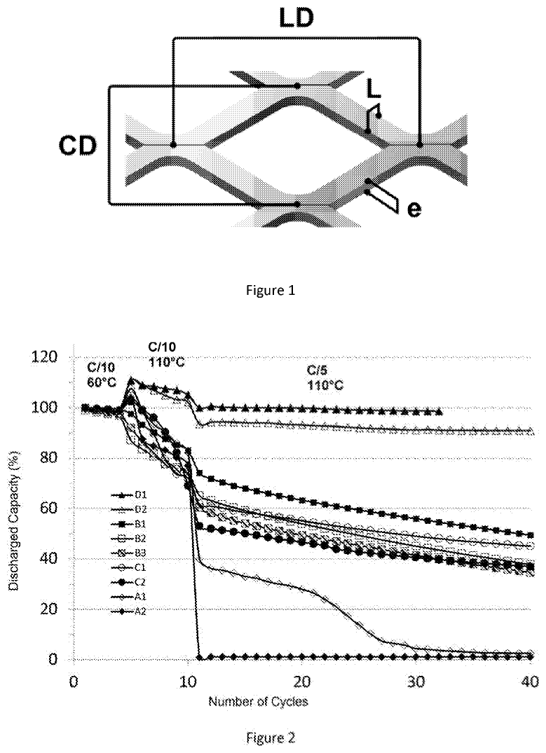

The grid used is preferably expanded metal. Expanded metal is produced by shearing a metal strip in a press equipped with knives. The knives create a series of evenly spaced notches in the strip. By stretching the metal perpendicular to the direction of the cuts, a metal mesh is created, usually rhombus-shaped, leaving voids surrounded by interconnected metal strands. FIG. 1 shows a top view of an expanded metal mesh. The rhombus formed is the result of the stretching of the metal. The metal strands delimit the rhombus. The dimensions of the rhombus as well as those of the metal strands are not limited in particular. However, typical size ranges are as follows:
each metal strand may have a width L of 0.10 to 3 mm, preferably of 0.18 to 2.5 mm;
the distance LD between the center of two interconnections of strands located on the longest diagonal of the rhombus varies from 0.4 mm to 50 mm, preferably from 0.6 to 43 mm.
the distance CD between the center of two interconnections of strands located on the shortest diagonal of the rhombus varies from 0.2 mm to 15 mm, preferably from 0.5 to 13 mm.
the thickness “e” of the expanded metal can vary from 25 μm to 2 mm, preferably from 120 μm to 1.5 mm, and more preferably from 300 μm to 1 mm.

The nature of the metal used for the grid is not limited. Preferably, it is aluminum or an aluminum alloy. Advantageously, the grid-shaped current collector is used for the one or more positive electrodes and the one or more negative electrodes. Furthermore, aluminum or aluminum alloy can be used as current collector material for the positive electrode and the negative electrode.

Manufacture of the Negative Electrode:

The negative active material is mixed with one or more of the above-mentioned binders, a solvent and generally one or more compounds with high electrical conduction properties, such as carbon. The result is a paste that is deposited on one or both sides of the current collector. The paste-coated current collector is laminated to adjust its thickness. A negative electrode is thus obtained.

The composition of the paste deposited on the negative electrode can be as follows:
from 75 to 90% negative active material, preferably from 80 to 85%;
from 5 to 15% binder(s), preferably 10%;
from 5 to 10% carbon, preferably 7.5%.

Manufacture of the Positive Electrode:

The same procedure is used as for the negative electrode but starting from positive active material.

The composition of the paste deposited on the positive electrode can be as follows:
from 75 to 90% negative active material, preferably from 80 to 90%.
from 5 to 15% binder(s), preferably 10%;
from 5 to 10% carbon, preferably 10%.

Separator:

The separator is one of the constituents that characterizes the cell according to the invention. It has a shrinkage of less than or equal to 3% in the direction of its length and in the direction of its width, after exposure to a temperature of 200° C. for a period of at least one hour. The skilled person can determine whether the separator meets this criterion by a simple comparison of the dimensions of the separator before and after exposure to 200° C. It was observed that the 3% shrinkage limit value was a critical value to allow the cell to operate at a temperature of at least 150° C. Beyond this value, electrical performance deteriorates rapidly. Preferably, the shrinkage value measured in both dimensions of the separator is less than or equal to 1%.

A practical test is to use a 20 cm long and 5 cm wide separator strip. The separator strip is attached to an aluminum foil via one end of the strip in the width direction. The assembly is placed in an oven at 200° C. for at least one hour. The length and width are then measured and compared to their initial values. Any variation greater than or equal to 3% in at least one of the dimensions makes the separator unsuitable for the cell.

Separators meeting this criterion may be selected from a polyester-based separator, a separator based on glass fibers bonded together by a polymer, a polyimide-based separator, a polyamide-based separator, a polyaramide-based separator, a polyamideimide-based separator and a cellulose-based separator. Polyester can be selected from polyethylene terephthalate (PET) and polybutylene terephthalate (PBT). Advantageously, the polyester contains or is coated with a material selected from the group consisting of a metal oxide, a carbide, a nitride, a boride, a silicide and a sulfide. This material can be SiO₂ or Al₂O₃.

Polyolefin-based separators are excluded from the invention because they have insufficient heat resistance.

Preferably, separators based on glass fibers not bonded together by a binding material, such as a polymer, are not used because they do not have sufficient flexibility to be used in cylindrical format cells.

Preferably, the separator is flexible enough to be wrapped around a cylinder with a diameter of 3 mm or more without tearing the separator. According to an embodiment, the separator can be wrapped around a cylinder with a diameter of 5 mm or more without tearing the separator. A skilled person can determine by a simple test, consisting of manually wrapping a separator around a cylinder, whether the separator meets this criterion. Preferably, a current collector or electrode is attached to the separator and wound around the cylinder. This test reproduces the spiral conditions of the separator in the electrochemical cell. It is preferably conducted with a grid-shaped current collector, as described above. This grid can be made of aluminum and have a thickness of about 300 μm.

The electrochemical assembly is formed by interposing a separator between the positive electrode and the positive electrode. In the case of a cylindrical cell, the electrochemical assembly is wound into a spiral and inserted into a cylindrical container.

Electrolyte:

The container provided with the electrochemical assembly is filled with an electrolyte consisting of at least one solvent and lithium salt(s).

The solvent for the electrochemical cell comprises an ionic liquid, i.e., a salt having a sufficiently low melting point that it is in the liquid state at the operating temperature of the electrochemical cell. The ionic liquid consists of the combination of an anion and a cation. The nature of the ionic liquid is not particularly limited.

Possible cations of the ionic liquid include imidazolium, pyrazolium, 1,2,4-triazolium, 1,2,3-triazolium, thiazolium, oxazolium, pyridazinium, pyrimidinium, pyrazinium, ammonium, phosphonium, pyridinium, piperidinium and pyrrolidinium. Preferably the cation of the ionic liquid is pyrrolidinium, preferably 1-butyl 1-methyl pyrrolidinium (BMP).

Possible anions of the ionic liquid include tetrafluoroborate BF₄⁻, hexafluorophosphate PF₆⁻, hexafluoroarsenate AsF₆⁻, bis(fluorosulfonyl)imide (FSO₂)₂N⁻ (FSI), bis(trifluoromethylsulfonyl)imide (TFSI) (CF₃SO₂)₂N⁻, bis(pentafluoroethylsulfonyl)imide (CF₃CF₂SO₂)₂N⁻, tris(pentafluoroethyl)trifluorophosphate (C₂F₅)₃PF₃⁻ (FAP), trifluoromethanesulfonate (triflate) CF₃SO₃⁻. The anion is preferably selected from tris(pentafluoroethyl)trifluorophosphate [(C₂F₅)₃PF₃]⁻ (FAP), bis(trifluoromethylsulfonyl)imide [(CF₃SO₂)₂N] (TFSI) and bis(fluorosulfonyl)imide (FSO₂)₂N⁻ (FSI).

The anion and the cation must be selected so that the ionic liquid is in the liquid state within the operating temperature range of the accumulator. Ionic liquid has the advantage of being thermally stable, non-flammable, non-volatile and of low toxicity. It is preferably selected from the group consisting of:
1-butyl 1-methyl pyrrolidinium bis(trifluoromethylsulfonyl)imide (BMP-TFSI),
1-butyl 1-methyl pyrrolidinium tris(pentafluoroethyl)trifluorophosphate (BMP-FAP),
ethyl-(2-methoxyethyl) dimethyl ammonium bis(trifluoromethylsulfonyl)imide,
1-methyl 1-propyl piperidinium bis(trifluoromethylsulfonyl)imide.

According to an embodiment, the ionic liquid makes up at least 90% by volume of the solvent, preferably at least 95%, more preferably at least 99%.

The solvent for the electrochemical cell may consist of a single ionic liquid or a mixture of different ionic liquids.

According to an embodiment, the solvent does not include any chemical compound acting as a solvent, other than the ionic liquid(s). Preferably, the solvent does not include cyclic or linear carbonate or cyclic or linear ester. Preferably, the solvent does not include ethers (glymes) or dioxolane.

At least one lithium salt is dissolved in the ionic liquid. The nature of this salt is not limited. A non-exhaustive list of examples of lithium salts is given below. The lithium salt may be selected from lithium hexafluorophosphate LiPF₆, lithium tetrafluoroborate LiBF₄, lithium trifluoromethanesulfonate LiCF₃SO₃, lithium bis(fluorosulfonyl)imide Li(FSO₂)₂N (LiFSI), lithium trifluoromethanesulfonimide LiN(CF₃SO₂)₂(LiTFSI), lithium trifluoromethanesulfonemethide LiC(CF₃SO₂)₃(LiTFSM), lithium bisperfluoroethylsulfonimide LiN(C₂F₅SO₂)₂(LiBETI), lithium 4,5-dicyano-2-(trifluoromethyl)imidazolide (LiTDI), lithium bis(oxalatoborate) (LiBOB), lithium tris(pentafluoroethyl)trifluorophosphate LiPF₃(CF₂CF₃)₃(LiFAP) and mixtures thereof.

Generally, the concentration of the lithium salt is about 1 mole per liter, usually between 0.7 and 1.5 mol/L.

It is preferred to use an electrolyte whose solvent is BMP-TFSI and whose lithium salt is LiTFSI.

The invention does not concern lithium-ion electrochemical cells containing a solid electrolyte. Indeed, due to the solid form of the electrolyte, such cells cannot be manufactured in cylindrical format, i.e. with a bundle of spiral plates.

An cell according to the invention typically comprises the combination of the following constituents:
a) at least one positive electrode comprising:
   i) a lithiated oxide of formula LiMO₂ where M is selected from the group consisting of Ni, Mn, Co, Al and a mixture thereof, and/or
   ii) a lithiated phosphate of formula LiMPO₄ wherein M is selected from the group consisting of Fe, Mn and a mixture thereof,
   (iii) PTFE and/or a polyimide as a binder,
   (iv) a current collector in the form of an aluminum grid
b) at least one negative electrode comprising:
   (i) Li₄Ti₅O₁₂
   (ii) PTFE as binder with or without polyvinyl alcohol, with or without a polyimide
   (iii) a current collector in the form of an aluminum grid
c) an electrolyte comprising BMP-TFSI and LiTFSI as lithium salt,
(d) a polymer-bonded glass fiber separator or a ceramic-reinforced PET separator, e.g. Al₂O₃.

Format of the Electrochemical Cell:

The format of the electrochemical cell is not particularly limited. It can be a prismatic, cylindrical, or pouch-type cell. Preferably, the format is cylindrical because it allows to obtain a high power.

According to an embodiment, the format of the electrochemical cell is not the button format.

The electrochemical cell according to the invention has an electrochemical capacity greater than 1 mAh, preferably greater than or equal to 5 mAh. It can still be greater than or equal to 100 mAh, or even greater than or equal to 1 Ah. It can be between 1 and 10 Ah.

According to an embodiment, the electrochemical cell has a standard cylindrical format “18650”, i.e. a diameter of 18.6 mm and a height of 65.2 mm.

The electrochemical cell has a standard cylindrical “D” format, i.e. a diameter of 32 mm and a height of 61.9 mm. Its capacity is up to 3.5 Ah.

The electrochemical cell according to the invention is capable of operating in charge and discharge at a temperature ranging from 150° C. to 200° C., preferably from 180 to 200° C.

According to a preferred embodiment, the electrochemical cell is capable of operating in charge and discharge at a temperature ranging from 165° C. to 200° C.

According to a preferred embodiment, the electrochemical cell is capable of operating in charge and discharge at a temperature ranging from 60° C. to 180° C.

Although capable of operating at high temperature, the electrochemical cell can also be used at room temperature (between 15 and 25° C.). It is also capable of operating in charge and discharge at temperatures ranging from 25° C. to 150° C. The electrochemical cell can be used in aeronautics, automotive, telecommunications, emergency power supply, railways and oil drilling.

### EXAMPLES

### Example 1

Lithium-ion electrochemical cells in button format of four types A, B, C and D were manufactured. Table 1 below indicates the nature of their constituents. The cells differ by the nature of the electrolyte used. Two type A cells A1 and A2 were manufactured. Three type B cells B1, B2 and B3 were manufactured. Two type C cells C1 and C2 were manufactured. Two type D cells D1 and D2 were manufactured.

TABLE 1

| | Composition of the | Composition of the | Composition of the | Nature of the |
|---|---|---|---|---|
| Cell | positive electrode | negative electrode | electrolyte | separator |
| A | LiFePO₄: 89% | Li₄Ti₅O₁₂: 90% | Solvents: | Glass fibers |
| (outside the | Polyimide binder: 5% | Polyimide binder: 5% | 50% PC/50% EC* + 2% VC | |
| invention) | Carbon: 6% | Carbon: 5% | Salt: LiPF₆ 1 mol/L | |
| B | | | Solvents: | |
| (outside the | | | 50% PC/50% EC* | |
| invention) | | | Salt: LiPFe 1 mol/L | |
| C | | | Solvent: PC: 100% | |
| (outside the | | | Salt: LiBETI 1 mol/L | |
| invention) | | | | |
| D | | | Solvent: BMP-TFSI | |
| (according to | | | Salt: LiTFSI 0.7 mol/L | |
| the invention) | | | | |

PC: propylene carbonate
EC: ethylene carbonate
VC: vinylene carbonate
BMP-TFSI: 1-butyl 1-methyl pyrrolidinium bis(trifluoromethylsulfonyl)imide
LiBETI: lithium bisperfluoroethylsulfonimide
LiTFSI: lithium trifluoromethanesulfonimide
*mass percentages expressed in relation to the sum of the masses of the solvents EC and PC

Type A, B, C and D cells were subjected to the following electrical test:
4 cycles at discharge regime C/10 at a temperature of 60° C.
6 cycles at discharge regime C/10 at a temperature of 110° C.
from the 11^{th} cycle onwards, cycling at discharge regime C/5 at a temperature of 110° C. (C denotes the rated capacity of the electrochemical cell)
   Cycling was performed between the minimum and maximum voltages of 1.1 V and 2.3 V.

The capacity discharged by the cells was recorded at the end of each discharge. The variation of the discharged capacity was represented as a function of the number of cycles performed. This variation is shown in FIG. 2. This figure shows that when the electrolyte solvent contains a carbonate (PEC or EC), the capacity loss is greater than 20% at the 11^{th} cycle. This is the case for type A, B and C cells. When the solvent for the electrolyte is an ionic liquid, the loss of capacity at the 11^{th} cycle is about 4%, which is the case for type D cells. After 40 cycles, the loss of capacity for these cells is still less than 10%. FIG. 2 therefore highlights the advantages of using the ionic liquid (BMP-TFSI) for a high-temperature application.

### Example 2

A lithium-ion electrochemical cell E in button format was manufactured. Table 2 below indicates the nature of its constituents. Cell E differs from cells of types A to D in, among other things, the nature of the positive active material which is a lithiated oxide of nickel, manganese and cobalt instead of LiFePO₄.

TABLE 2

| | Composition of the | Composition of the | Composition of the | Nature of the |
|---|---|---|---|---|
| Cell | positive electrode | negative electrode | electrolyte | separator |
| E | LiN_{1/3}Mn_{1/3}Co_{1/3}: | Li₄Ti₅O₁₂: 80% | Solvent: BMP-TFSI | Ceramic (Al₂O₃) |
| (according to | 80% | PTFE binder: 10% | Salt: LiTFSI 0.7 mol/L | reinforced |
| the invention) | PTFE binder: 10% | Carbon: 10% | | polyester (PET) |
| | Carbon: 10% | | | |

PET: polyethylene terephthalate
PTFE: polytetrafluoroethylene
BMP-TFSI: 1-butyl 1-methyl pyrrolidinium bis(trifluoromethylsulfonyl)imide
LiTFSI: lithium trifluoromethanesulfonimide

Electrical Test 1:

Cell E was subjected to the following electrical test:
1 cycle at discharge regime C/10 at a temperature of 150° C.
20 cycles at discharge regime C/5 at a temperature of 150° C.
   Cycling was performed between the minimum and maximum voltages of 1.5 V and 2.4 V.

The capacity discharged by the cell was recorded at the end of each discharge. The discharged capacity was represented according to the number of cycles performed. This variation is shown in FIG. 3, which shows that the loss of capacity in the 20^{th} cycle is 28%, which is satisfactory.

Electrical Test 2:

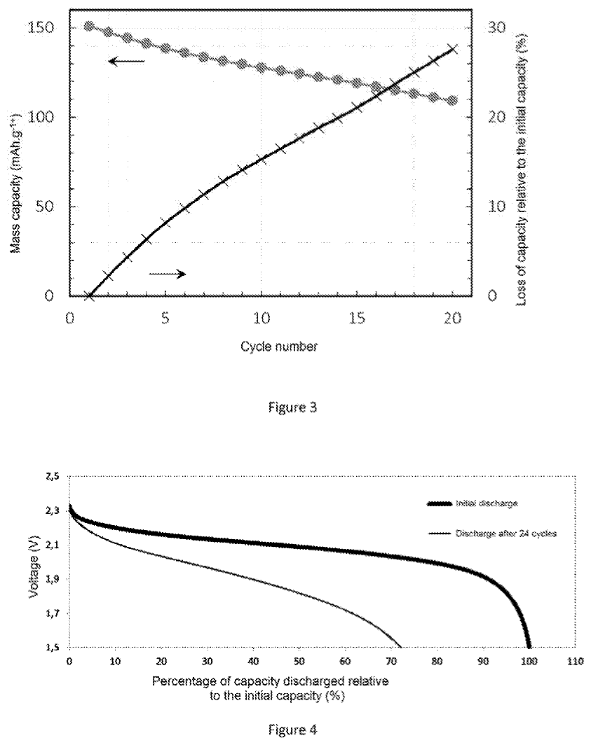

Cell E was then placed at a temperature of 150° C. and subjected to the following electrical test:
discharge at regime C/6 to bring it to a 25% state of charge;
22 charge/discharge cycles between the states of charge of 25 and 75% at discharge regime C/6,
at the 24^{th} cycle, a control cycle comprising a discharge of the cell at regime C/6 up to the stop voltage of 1.5 V was performed. The capacity returned by the cell during this discharge was measured. FIG. 4 is a comparison between the discharge curve of cell E during the initial discharge and the discharge curve of this cell during the control cycle after 24 cycles. The loss of capacity compared to the initial capacity of the cell is only 27%, which is satisfactory.

Electrical tests conducted on cell E demonstrate that the cell can be used at a temperature of at least 150° C. without significant loss of capacity.

1. A lithium-ion electrochemical cell comprising:
at least one negative electrode comprising an active material having an operating potential greater than or equal to 1 V with respect to the potential of the electrochemical couple Li⁺/Li;
at least one positive electrode;
the negative electrode and/or the positive electrode comprising a binder selected from polytetrafluoroethylene, polyamideimide, polyimide, styrene-butadiene rubber and polyvinyl alcohol or a mixture thereof;
a liquid electrolyte comprising a solvent which is an ionic liquid;
a separator having a shrinkage of less than or equal to 3% in the direction of its length and in the direction of its width, after exposure to a temperature of 200° C. for a period of at least one hour.

2. The electrochemical cell as claimed in claim 1, wherein the separator further has the property that it can be wrapped around a cylinder with a diameter greater than or equal to 3 mm without tearing of the separator being observed.

3. The electrochemical cell as claimed in claim 1, wherein the active material having an operating potential greater than or equal to 1 V with respect to the electrochemical couple potential Li⁺/Li is selected from the group consisting of:
a) LiₐTi_{b}O₄ where 0.5≤a≤3 and 1≤b≤2.5;
b) LiₓMg_{y}Ti_{z}O₄ where x>0; 0.01≤y≤0.20; z>0; 0.01≤y/z≤0.10 and 0.5≤(x+y)/z≤1.0;
c) Li_{4+y}Ti_{5-d}M²_{d}O₁₂ where M² is at least one element selected from the group consisting of Mg, Al, Si, Ti, Zn, Zr, Ca, W, Nb, and Sn, with −1≤y≤3.5 and 0≤d≤0.1;
d) H₂Ti₆O₁₃;
e) H₂Ti₁₂O₂₅;
f) TiO₂;
g) LiₓTiNb_{y}O_{z} where 0≤x≤5; 1≤y≤24; 7≤z≤62;
h) LiₐTiM_{b}Nb_{c}O_{7+σ} where 0≤a≤5; 0≤b≤0.3; 0≤c≤10; −0.3≤σ≤0.3 and M is at least one element selected from the group consisting of Fe, V, Mo and Ta;
i) Nb_{α}Ti_{β}O_{7+γ} where 0≤α≤24; 0≤β≤1; −0.3≤γ≤0.3;
and mixtures thereof.

4. The electrochemical cell as claimed in claim 3, wherein the active material having an operating potential greater than or equal to 1 V with respect to the electrochemical couple potential Li⁺/Li is Li₄Ti₅O₁₂.

5. The electrochemical cell as claimed in one of claim 1, wherein the active material having an operating potential greater than or equal to 1 V with respect to the electrochemical couple potential Li⁺/Li, has a carbon-based coating.

6. The electrochemical cell as claimed in claim 1, wherein the separator is selected from the group consisting of:
a polyester-based separator,
a separator based on glass fibers bonded together by a polymer,
a polyimide-based separator,
a polyamide-based separator,
a polyamideimide-based separator,
a polyaramide-based separator, and
a cellulose-based separator.

7. The electrochemical cell as claimed in claim 6, wherein the separator contains or is coated with a material selected from the group consisting of a metal oxide, a carbide, a nitride, a boride, a silicide and a sulfide.

8. The electrochemical cell as claimed in claim 1, wherein the ionic liquid is selected from the group consisting of:
1-butyl 1-methyl pyrrolidinium bis(trifluoromethylsulfonyl)imide (BMP-TFSI),
1-butyl 1-methyl pyrrolidinium tris(pentafluoroethyl)trifluorophosphate (BMP-FAP),
ethyl-(2-methoxyethyl) dimethyl ammonium bis(trifluoromethylsulfonyl)imide,
1-methyl 1-propyl piperidinium bis(trifluoromethylsulfonyl)imide.

9. The electrochemical cell as claimed in claim 1, comprising a lithium salt dissolved in the ionic liquid, which salt is selected from the group consisting of:
lithium hexafluorophosphate LiPF₆,
lithium tris(pentafluoroethyl)trifluorophosphate LiFAP,
lithium bisoxalatoborate LiBOB,
lithium hexafluoroarsenate LiAsF₆,
lithium tetrafluoroborate LiBF₄,
lithium trifluoromethanesulfonate LiCF₃SO₃,
lithium trifluoromethane sulfonimide LiN(CF₃SO₂)₂(LiTFSI) and lithium trifluoromethanesulfonemethide LiC(CF₃SO₂)₃(LiTFSM), preferably LiTFSI.

10. The electrochemical cell as claimed in claim 1, wherein the negative electrode and/or the positive electrode comprises a current collector which is a metal grid.

11. The electrochemical cell as claimed in claim 10, wherein the grid metal is aluminum or an aluminum-based alloy.

12. The electrochemical cell as claimed in claim 10, wherein the grid has a thickness less than or equal to 500 μm, preferably less than or equal to 300 μm.

13. The electrochemical cell as claimed in claim 1, comprising at least one positive electrode comprising an active material selected from the group consisting of:
compound i) of formula LiₓMn_{1-y-z}M′_{y}M″_{z}PO₄ (LMP), where M′ and M″ are different from each other and are selected from the group consisting of B, Mg, Al, Si, Ca, Ti, V, Cr, Fe, Co, Ni, Cu, Zn, Y, Zr, Nb and Mo, with 0.8≤x≤1.2; 0≤y≤0.6; 0≤z≤0.2;
a compound ii) of formula LiₓFe_{1-y}M_{y}PO₄ (LFMP) where M is selected from the group consisting of B, Mg, Al, Si, Ca, Ti, V, Cr, Mn, Co, Ni, Cu, Zn, Y, Zr, Nb and Mo; and 0.8≤x≤1.2; 0≤y≤0.6,
a compound iii) of formula LiₓM_{1-y-z-w} M′_{y}M″_{z}M′″_{w}O₂ (LMO2) where M, M′, M″ and M′″ are selected from the group consisting of B, Mg, Al, Si, Ca, Ti, V, Cr, Mn, Fe, Co, Ni, Cu, Zn, Y, Zr, Nb, W and Mo provided that at least M or M′ or M″ or M′″ is selected from Mn, Co, Ni, or Fe; M, M′, M″ and M′″ being different from each other; and 0.8≤x≤1.4; 0≤y≤0.5; 0≤z≤0.5; 0≤w≤0.2 and x+y+z+w<2.1.

14. Method of using an electrochemical cell, said method-comprising the step of charging or discharging at a temperature of 150° C. or higher an electrochemical cell as claimed in claim 1.
